(19) United States
(12) Patent Application Publication
(10) Pub. No.: US 2021/0052083 A1
(43) Pub. Date: Feb. 25, 2021

(54) CONVERTIBLE INFLATABLE APPARATUS

(71) Applicant: BESTWAY INFLATABLES & MATERIAL CORP., Shanghai (CN)

(72) Inventors: Shuiyong HUANG, Shanghai (CN); Bingrong WU, Shanghai (CN); Xinru CHEN, Shanghai (CN)

(21) Appl. No.: 16/965,002

(22) PCT Filed: Jan. 31, 2018
(86) PCT No.: PCT/CN2018/074776

§ 371 Date: Jul. 26, 2020

(51) Int. Cl. A47C 27/08; A47C 27/10

(52) U.S. Cl. CPC A47C 27/081; B63B 34/52; A47C 27/10

(57) ABSTRACT

A convertible inflatable apparatus (100) includes an inflatable mattress (102) having a headrest portion (122) and a footrest portion (124) as well as an inflatable support (104) having a wedge portion (116) and a tube portion (118). The inflatable support (104) is flexibly coupled to the inflatable mattress (102), and the inflatable support (104) is foldable beneath the inflatable mattress (102).

### TECHNICAL FIELD

The present subject matter relates to inflatables, and more particularly, to adjustable inflatable mattresses.

### BACKGROUND

Often times, inflatable consumer goods, such as inflatable mattresses, inflatable chairs, other inflatable furniture, etc., are constructed to have a fixed shape upon inflation thereof. An inflatable, such as an inflatable mattress, that is easily manipulated to change in shape and configuration represents an improvement in the art.

In the current state of the art; however, the addition of one or more inflatable bladders to adjust the incline of a bed/mat is inconvenient. Sometimes, pillows and/or other inflatable bladders are inserted into and/or around a bed to prop up or support a user. Typically, these methods or systems require numerous inflatable bladders and are it is both time-consuming and inconvenient to inflate and assemble separate components. To solve this challenge, the below disclosure sets forth a convertible inflatable apparatus that may be converted from an inflatable mattress to an inflatable reclining mattress.

The description provided in the background section should not be assumed to be prior art merely because it is mentioned in or associated with the background section. The background section may include information that describes one or more aspects of the subject technology.

### SUMMARY

According to an aspect of the present disclosure, a convertible inflatable apparatus includes an inflatable mattress having a headrest portion and a footrest portion as well as an inflatable support having a wedge portion and a tube portion. Further in accordance with this aspect, the inflatable support is flexibly coupled to the inflatable mattress, and the inflatable support is foldable beneath the inflatable mattress.

According to another aspect of the present disclosure, an inflatable device includes an inflatable mattress, a wedge, a tube, and an intermediate portion such that the wedge is coupled to the tube by the intermediate portion thereby forming a support portion. This inflatable device further has a first configuration wherein the inflatable mattress is flat, and a second configuration wherein the support portion contours the inflatable mattress into a shape suitable for reclining.

Other aspects and advantages of the present invention will become apparent upon consideration of the following detailed description and the attached drawings wherein like numerals designate like structures throughout the specification.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example convertible inflatable with a support portion partially beneath a mattress portion;

FIG. 2 illustrates another example convertible inflatable with a support portion extending away from a mattress portion;

FIG. 3 is a left side isometric view of the convertible inflatable of FIG. 2 with the support portion beneath the mattress portion;

FIG. 4 is an end isometric view of the convertible inflatable of FIG. 2 with the support portion coupled beneath the mattress portion and further showing a strap for coupling the support portion to the mattress portion;

FIG. 5 is a right side isometric view of the convertible inflatable of FIG. 2 with the support portion coupled to the underside of the mattress portion; and

FIG. 6 is a partial bottom plan view of the underside of the convertible inflatable of FIG. 2 further showing another strap for coupling the support portion to the mattress portion.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Still further, modules and processes depicted may be combined, in whole or in part, and/or divided, into one or more different parts, as applicable to fit particular implementations without departing from the scope of the present disclosure. Accordingly, the drawings and description are to be regarded as illustrative in nature and not restrictive.

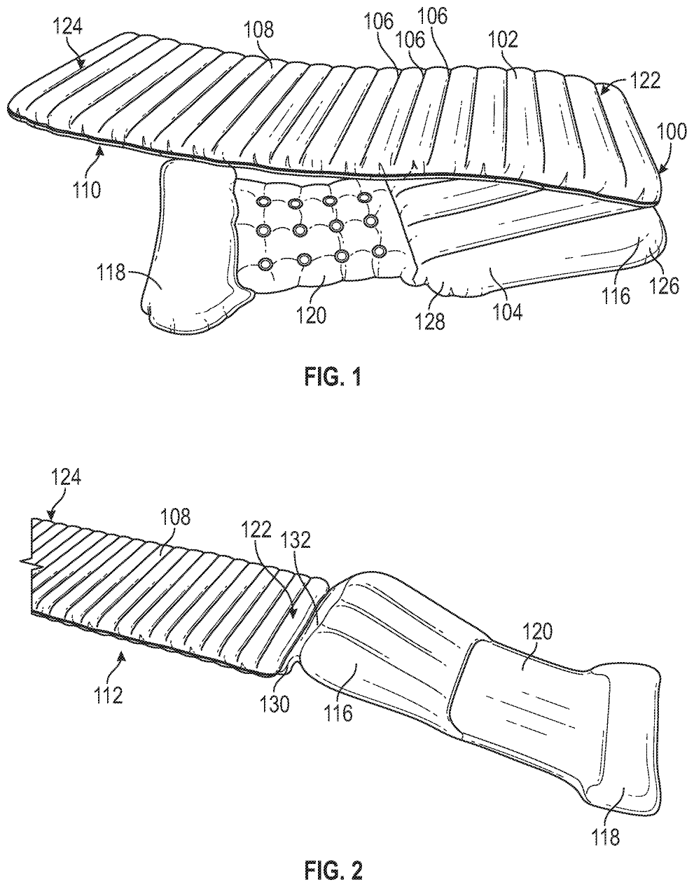

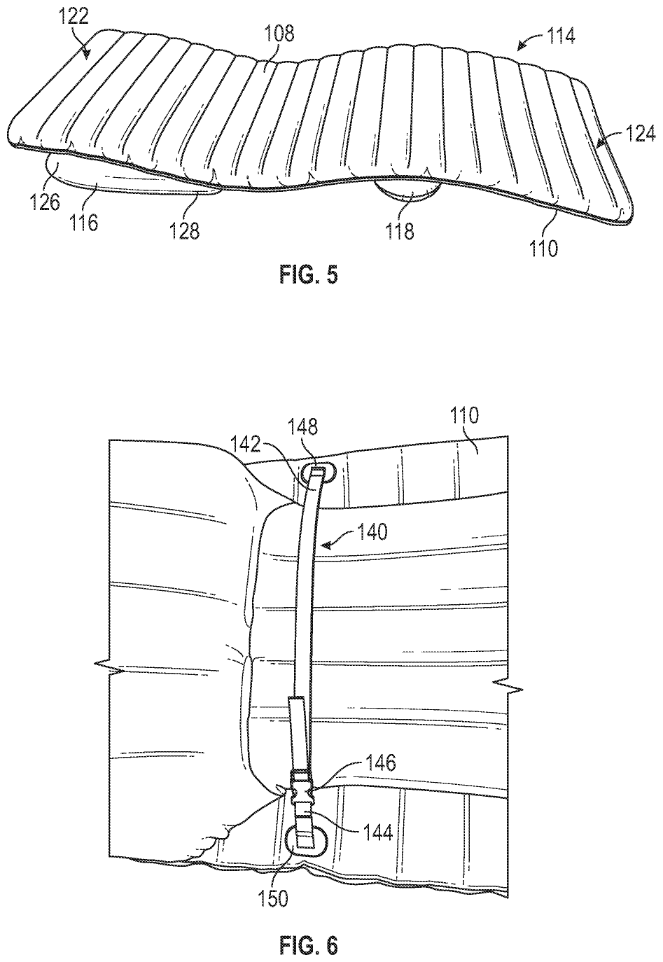

Referring now to FIG. 1, a convertible inflatable apparatus 100 is depicted with a mattress portion/plenum 102 and an inflatable support portion/plenum 104. The mattress portion 102 is generally cuboid in shape, and, in example embodiments, the mattress portion 102 is an inflatable mattress. The inflatable mattress portion 102 may be divided into one or more chambers/plenums for inflation. In an example embodiment, the mattress portion 102 may have one or more ridges 106 disposed on first and/or second surfaces 108, 110 thereof. The one or more ridges 106 may provide flexion and/or extension thereabout. Accordingly, the mattress portion 102 may have a flat configuration 112 (FIG. 2) or a contoured configuration 114 (FIG. 5). The mattress portion 102 may bend along the one or more ridges to undertake the contoured configuration 114.

The contoured configuration 114 may provide leg, head, and/or lumbar support to a user of the convertible inflatable apparatus 100. In an example embodiment, the contoured configuration 114 is shaped as a reclining chair/mat/pad and/or a lounge chair/mat/pad. The mattress portion 102 comprises a first, headrest end 122 and a second, footrest end 124. In example embodiments, the headrest end 122 and the footrest end 124 may be interchanged relative one another according to use thereof by the user.

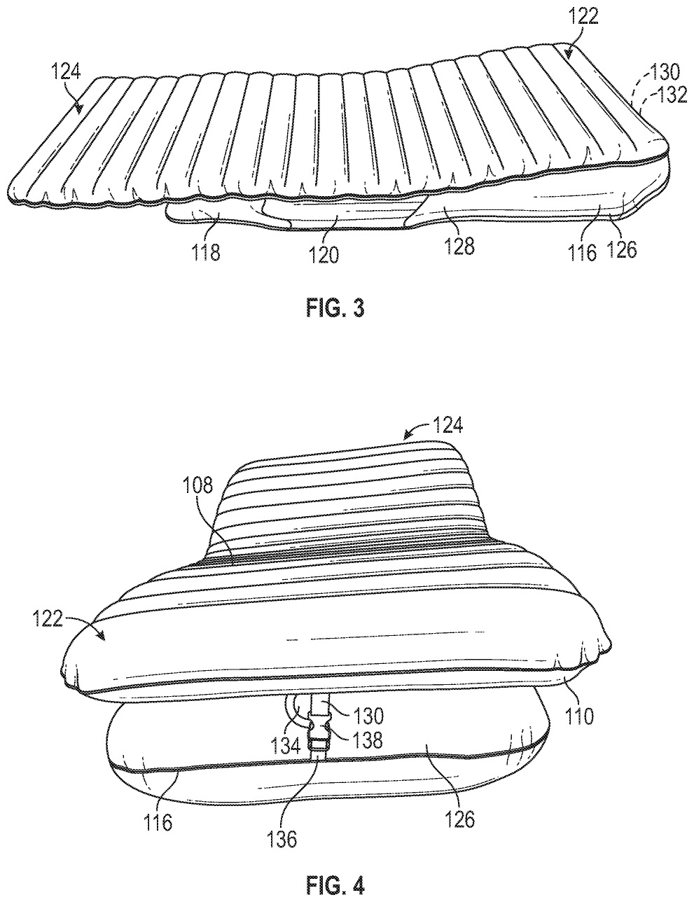

The inflatable support portion/plenum 104 comprises a first, wedge portion/plenum 116 and a second, tube-shaped portion/plenum 118 with an intermediate portion/plenum 120 extending therebetween. In example embodiments, the intermediate portion 120 may be a non-inflated, flat portion (such as one or more sheets of fabric, plastic, mesh, and/or another suitable material) or other connection instead of a plenum. The wedge portion 116 further has relatively thick and thin portions 126, 128. The relatively thick portion 126 is disposed proximal the headrest end 122 of the mattress portion 102. A coupling component 130 is configured to couple the support portion 104 to the mattress portion 102. In the example embodiment of FIGS. 2 and 3, the coupling component 130 is a relatively thin sheet 132 made of plastic, such as polyvinyl chloride (PVC), fabric, and/or another suitable material. In this example embodiment, the coupling component 130 flexibly attaches the thick portion 126 of the wedge portion 116 to the headrest end 122 of the mattress portion 102. The coupling component 122 is flexible such that the support portion 104 may be folded underneath the mattress portion 102, as illustrated in FIG. 3, thereby developing the contoured configuration 114.

Referring now to FIG. 3, in the contoured configuration 114, the wedge portion 116 is disposed proximal the headrest end 122 and is folded underneath the headrest end 122 such that the wedge portion 116 abuts the second surface 110 of the mattress portion 102. In the illustrated example embodiment, the second surface 110 is a bottom surface of the mattress portion 102 and the first surface 108 of the mattress portion 102 is a top and/or user surface, i.e., the surface upon which the user reclines. However, in example embodiments the first and second surfaces 108, 110, may be interchanged, flipped, and/or reversible. An example embodiment may provide for the support portion 104 to fold towards either the first or second surface 108, 110 of the mattress portion 102 thereby allowing the user to alternate the surface reclined upon.

Again, when the convertible inflatable apparatus 100 is in the contoured configuration 114, the intermediate portion 120 of the support portion 104 extends away from the thin portion 128 of the wedge portion 116 towards the footrest end 124 of the mattress portion 102. The intermediate portion 120 connects the wedge portion 116 to the tube-shaped portion 118 disposed beneath the mattress portion 102 part-way between the proximate middle of the mattress portion 102 and the footrest end 124 of the mattress portion 102. In the contoured configuration 114, the tube-shaped portion 118 is arranged abutting the second surface 110 of the mattress portion 102 proximal, and opposite, where the knees and/or legs of a typical user contact the first surface 108 of the mattress portion 102.

The relative locations of the wedge portion 116, the intermediate portion 120, and the tube-shaped portion 118 underneath the mattress portion 102 and abutting the second surface 110 thereof develop an arcuate profile for the mattress portion 102. In the example embodiment(s) of FIGS. 3 and 5, the support portion 104 folds the mattress portion 102 into an s-shaped curve suitable for the user to recline in while receiving support for the mattress 102 beneath the head, shoulders, and legs. The contour of the mattress portion 102 when the convertible inflatable apparatus 100 is in the contoured configuration 114 may suitably prop up the head and shoulders of the user at an incline relative the pelvis. Further, the contoured configuration 114 may support the legs of the user such that the upper legs are propped up at an incline relative the pelvis and opposite the upper body. Additionally, the lower legs may be allowed to rest at a downward incline relative the upper legs, providing a comfortable bend in the knee of the user.

Referring now to FIG. 4, an embodiment of the convertible inflatable apparatus 100 is depicted with an alternative coupling component 130. In the example embodiment of FIG. 4, the coupling component 130 comprises first and second straps 134, 136 and a clip 138. The first strap 134 is flexibly attached to the headrest end 122 of the mattress portion 102, and the second strap 136 is flexibly attached to the thick portion 126 of the wedge portion 116 of the support portion 104. Thusly, similar to the arrangement of the thin sheet 132 of the coupling component 130, the straps 134, 136 and clip 138 provide for the support portion 104 to fold beneath the mattress portion 102 and abut the second surface 110 thereof. Further, the support portion 102 when abutting the second surface 104 supports the mattress portion 102 such that when the user reclines thereon, the mattress portion 102 folds into an arcuate shape suitable for reclining. FIG. 5 depicts the example embodiment of FIG. 4 in a side view further illustrating an example s-curve of the mattress portion 102 developed when the support portion 104 is folded underneath the second surface 110 of the mattress portion 102.

In the example embodiment(s) of FIGS. 4 and 5, the support portion 104 is removable from the mattress portion 102 by way of the clip 138. Therefore, the mattress portion 102 and the support portion 104 may be used separately, when inflated, or may be stored separately when deflated. For example, the convertible inflatable apparatus 100 may be a personal floatation device for use with swimming and water recreation. In this embodiment, the convertible inflatable apparatus 100 may be separated such that the mattress portion 102 and the support portion 104 are usable separately as floatation devices or as independent air mattresses/cushions. Then, when the user desires to recline/lounge, the mattress portion 102 and the support portion 104 may be combined, by way of the straps 134, 136 and the clip 138, such that the convertible inflatable apparatus 100 may take on the contoured configuration 114. Still further, in example embodiments the support portion 104 and/or the mattress portion 102 may be modular and interchangeable, one for another, such that new/replacement support portion(s) 104 may be coupled to the mattress portion 102, including support portion(s) 104 having different shapes for providing varying gradients of incline/contour. Also, the mattress portion 102 may be replaced in response to wear and tear same is subjected thereto. Together or apart, these modular components may be made available to user(s) as a modular system with interchangeable and/or inter-fitting components.

Referring now to FIG. 6, a second coupling component 140 is illustrated. The second coupling component 140 comprises first and second straps 142, 144 and a clip 146. The straps 142, 144 are flexibly attached to the second, bottom surface 110 of the mattress portion 102 at first and second strap connection/anchor points 148, 150. The first and second straps 142, 144 extend out from the second surface 110 of the mattress portion and partially surround the support portion 104. The first and second straps 142, 144, when clipped together by the clip 146 and partially surrounding the support portion 104, hold the support portion 104 against the underside 110 of the mattress portion 102. The second coupling component 140 may operate together with the first coupling component 130 to attach the support portion 104 to the mattress portion 102 and hold the support portion 104 in place relative the mattress portion 104. The second coupling component 140 further restricts lateral movement of the support portion 104. Restriction of lateral movement of the support portion 104 may assist in maintaining the shape of the convertible inflatable apparatus 100 when same is in the contoured configuration 114. It may be beneficial to hold the support portion 104 in place during user so as to maintain a consistent incline and more satisfying user experience. The first and second coupling components 130, 140 may be supplemented and/or replaced, in whole or in part, by one or more strips/patches of complementary hook and loop fastener (such as Velcro®) disposed in corresponding locations on the support portion 104 and the mattress portion 102.

The embodiment(s) detailed hereinabove may be combined in full or in part, with any alternative embodiment(s) described.

### INDUSTRIAL APPLICABILITY

The above disclosure may represent an improvement in the art because it provides for use of an inflatable apparatus according to conversion principles described hereinthroughout. Further, the convertible inflatable apparatus provides the user with improved comfort and satisfaction in addition to convenient manipulation of the inflatable apparatus from one shape to another. Still further, the disclosure improves the art by supplying an alternative construction for an inflatable recliner.

It is to be understood that all described elements and features in this disclosure can be formed of any number of materials including, but not limited to, polymers, woven or overlaid fibers, composites, rubbers, foams, ceramics, metals, metal alloys or any other material known to those skilled in the art. In particular, the material forming convertible inflatable apparatus 100 and/or the plenums forming same may be plastic, vinyl, coated fabric, and/or another suitable material or combination of materials. Valve(s) disposed on these components may be formed from extruded plastic, machined aluminum, another metal alloy, and/or another materials or combination of materials suitable for manufacturing valve(s) for inflatables.

While some implementations have been illustrated and described, numerous modifications come to mind without significantly departing from the spirit of the disclosure; and the scope of protection is only limited by the scope of the accompanying claims.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The disclosed systems and methods are well adapted to attain the ends and advantages mentioned as well as those that are inherent therein. The particular implementations disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative implementations disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

In one aspect, a term coupled or the like may refer to being directly coupled. In another aspect, a term coupled or the like may refer to being indirectly coupled. Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

The use of the terms “a” and “an” and “the” and “said” and similar references in the context of describing the invention (especially in the context of the following claims) are to be construed to cover both the singular and the plural, unless otherwise indicated herein or clearly contradicted by context. An element proceeded by “a,” “an,” “the,” or “said” does not, without further constraints, preclude the existence of additional same elements. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

What is claimed is:

1. A convertible inflatable apparatus, comprising:
an inflatable mattress having a headrest portion and a footrest portion; and
an inflatable support having a wedge portion and a tube portion;
wherein the inflatable support is flexibly coupled to the inflatable mattress; and
wherein the inflatable support is foldable beneath the inflatable mattress.

2. The convertible inflatable apparatus of claim 1 comprising a flat configuration and a contoured configuration;
wherein the convertible inflatable apparatus is interchangeable between the flat configuration and the contoured configuration.

3. The convertible inflatable apparatus of claim 1, wherein, when in the contoured position, the wedge portion of the inflatable support is disposed beneath the headrest portion of the inflatable mattress, and the tube portion of the inflatable support is disposed beneath the inflatable mattress proximal the footrest portion thereof.

4. The convertible inflatable apparatus of claim 1, wherein the inflatable support is flexibly coupled to the inflatable mattress by one or more straps.

5. The convertible inflatable apparatus of claim 1, wherein the inflatable support is flexibly coupled to the inflatable mattress by a sheet of PVC.

6. The convertible inflatable apparatus of claim 1, wherein the inflatable support is coupled to the inflatable mattress with complementary sections of hook and loop fastener.

7. An inflatable device, comprising:
an inflatable mattress;
a wedge;
a tube; and
an intermediate portion;
wherein the wedge is coupled to the tube by the intermediate portion thereby forming a support portion;
wherein, in a first configuration, the inflatable mattress is flat; and
wherein, in a second configuration, the support portion contours the inflatable mattress into a shape suitable for reclining.

8. The inflatable device of claim 7, wherein the wedge and the tube further comprise inflatable plenums.

9. The inflatable device of claim 7, wherein the wedge supports a headrest portion of the inflatable mattress; and wherein the tube supports a portion of the mattress proximal to the knees of a typical user.

10. The inflatable device of claim 7, wherein at least one of the support portion and the inflatable mattress is modular.

11. The inflatable device of claim 7, further comprising at least one strap having first and second connection points on a side of the inflatable mattress;
wherein the at least one strap couples the support portion to the inflatable mattress by strapping the intermediate portion of the support portion to the inflatable mattress.
